SEQUENCE LISTING (35 sequences)

SEQ ID NO: 1 - DNA, 405 bp, Aspergillus nidulans
  CDS (1)..(405): basf-dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  basf-dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): basf-rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  basf-rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  CDS (1)..(336): Chemically synthesized polynucleotide basf-hypA
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  basf-hypA from chemically synthesized polynucleotide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  CDS (1)..(357): chemically synthesized polynucleotide basf-hypB
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  basf-hypB from chemically synthesized polynucleotide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): basf-sc3 hydrophobin, cDNA template
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  basf-sc3 hydrophobin, cDNA
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): chemically synthesized polynucleotide basf-BASF1
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  basf-BASF1 from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): chemically synthesized polynucleotide basf-BASF2
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  basf-BASF2 from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): basf-yaad yaaD
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  basf-yaad yaaD
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): basf-yaae yaaE with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  basf-yaae yaaE with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): basf-yaad-Xa-dewA-his fusion of Bacillus subtilis yaaD and N-terminal factor Xa proteinase cleavage site and Aspergillus nidulans hydrophobin dewA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  basf-yaad-Xa-dewA-his fusion of Bacillus subtilis yaaD and N-terminal factor Xa proteinase cleavage site and Aspergillus nidulans hydrophobin dewA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): basf-yaad-Xa-rodA-his fusion of Bacillus subtilis yaaD and N-terminal factor Xa proteinase cleavage site and Aspergillus nidulans hydrophobin rodA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  basf-yaad-Xa-rodA-his fusion of Bacillus subtilis yaaD and N-terminal factor Xa proteinase cleavage site and Aspergillus nidulans hydrophobin rodA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): basf-yaad-Xa-BASF1-his fusion of Bacillus subtilis yaaD and N-terminal factor Xa proteinase cleavage site and artificial hydrophobin BASF1; BASF1 from chemically synthesized polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  basf-yaad-Xa-BASF1-his fusion of Bacillus subtilis yaaD and N-terminal factor Xa proteinase cleavage site and artificial hydrophobin BASF1; BASF1 from chemically synthesized polynucleotide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 28 bp, Artificial Sequence
  Chemically synthesized Hal570 primer
gcgcgcccatggctcaaacaggtactga

SEQ ID NO: 26 - DNA, 28 bp, Artificial Sequence
  Chemically synthesized Hal571 primer
gcagatctccagccgcgttcttgcatac

SEQ ID NO: 27 - DNA, 30 bp, Artificial Sequence
  Chemically synthesized Hal572 primer
ggccatgggattaacaataggtgtactagg

SEQ ID NO: 28 - DNA, 33 bp, Artificial Sequence
  Chemically synthesized Hal573 primer
gcagatcttacaagtgccttttgcttatattcc

SEQ ID NO: 29 - DNA, 38 bp, Artificial Sequence
  Chemically synthesized KaM416 primer
gcagcccatcagggatccctcagccttggtaccagcgc

SEQ ID NO: 30 - DNA, 50 bp, Artificial Sequence
  Chemically synthesized KaM417 primer
cccgtagctagtggatccattgaaggccgcatgaagttctccgtctccgc

SEQ ID NO: 31 - DNA, 45 bp, Artificial Sequence
  Chemically synthesized KaM434 primer
gctaagcggatccattgaaggccgcatgaagttctccattgctgc

SEQ ID NO: 32 - DNA, 30 bp, Artificial Sequence
  Chemically synthesized KaM435 primer
ccaatggggatccgaggatggagccaaggg

SEQ ID NO: 33 - DNA, 38 bp, Artificial Sequence
  Chemically synthesized KaM418 primer
ctgccattcaggggatcccatatggaggagggagacag

SEQ ID NO: 34 - DNA, 32 bp, Artificial Sequence
  Chemically synthesized KaM464 primer
cgttaaggatccgaggatgttgatgggggtgc

SEQ ID NO: 35 - DNA, 35 bp, Artificial Sequence
  Chemically synthesized KaM465 primer
gctaacagatctatgttcgcccgtctccccgtcgt

(19) United States
(12) Patent Application Publication
(10) Pub. No.: US 2009/0297884 A1
(43) Pub. Date: Dec. 3, 2009

(54) Use of hydrophobins for the surface treatment of hardened mineral building materials, natural stone, artificial stone and ceramics

(75) Inventors: Heike Becker, Mannheim (DE); Claus Bollschweiler, Heidelberg (DE); Thomas Subkowski, Ladenburg (DE); Ulf Baus, Dossenheim (DE); Hans-Georg Lemaire, Limburgerhof (DE); Marvin Karos, Schwetzingen (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/887,127

(22) PCT Filed: Mar. 28, 2006
(86) PCT No.: PCT/EP2006/061092

§ 371 Date: Sep. 24, 2007

(30) Foreign Application Priority Data
Mar. 30, 2005 (DE) 102005014843.3
Jul. 29, 2005 (DE) 102005036339.3

(51) Int. Cl. B32B 9/04; B28B 19/00; C04B 41/48; C04B 41/62; C04B 41/82

(52) U.S. Cl. 428/689

(57) ABSTRACT

Use of hydrophobins for treating the surface of cured mineral building materials, natural stone, cast stone or ceramic, a process for treating such surfaces and also surfaces of cured mineral building materials, natural stone, cast stone or ceramic that have a coating comprising hydrophobins.

The present invention concerns the use of hydrophobins for treating the surface of cured mineral building materials, natural stone, cast stone or ceramic, a process for treating such surfaces and also surfaces of cured mineral building materials, natural stone, cast stone or ceramic that have a coating comprising hydrophobins.

It is known for surfaces both indoors and outdoors to be coated with coatings to improve the durability and/or the appearance of the surface. Such coatings shall for example preserve, repel moisture, inhibit soiling or facilitate cleaning of the surface.

The coatings can be permanent coatings, for example coatings inspired by the lotus effect, as disclosed by EP-A 933 388.

The coatings can also be temporary coatings. Such a temporary soil-repellent effect can be achieved for example via substances in a cleanser formulation which are applied in the course of the surface being cleaned. They can be cleansers for tiles for example.

WO 03/002620 discloses the use of dialkylaminoalkyl (meth)acrylates as soil release polymers for hard surfaces, for example fine-stone floors or stainless-steel surfaces. The formulations disclosed comprise 0.1% to 5% by weight of the polymer.

DE-A 100 61 897 discloses cleaning compositions comprising hydrophilic, silicate-containing particles that lead to improved soil detachment coupled with reduced resoiling. The particles are taken up by the surface of the substances to be cleaned and accordingly affect the properties of the surface.

Hydrophobins are small proteins of about 100 to 150 amino acids that are characteristic of filamentous fungi, for example Schizophyllum commune. They generally have 8 cysteine units.

Hydrophobins have a marked affinity for interfaces and therefore are useful for coating surfaces. For instance, Teflon can be coated with hydrophobins to obtain a hydrophilic surface.

Hydrophobins can be isolated from natural sources. But it is also possible to synthesize non-naturally-occurring hydrophobins by means of chemical and/or biotechnological methods of production. Our prior application DE 102005007480.4 discloses a process for producing hydrophobins that do not occur in nature.

There is prior art proposing the use of hydrophobins for various applications.

WO 96/41882 proposes the use of hydrophobins as emulgators, thickeners or surfactants, for giving hydrophilic properties to hydrophobic surfaces, for improving water-resistance of hydrophilic substrates, for preparing oil-in-water emulsions or water-in-oil emulsions. Further proposals include pharmaceutical applications such as the preparation of ointments or creams and also cosmetic applications such as skin protection or the production of shampoos or conditioners.

EP-A 1 252 516 discloses the coating of windows, contact lenses, biosensors, medical devices, containers for performing assays or for storage, ships hulls, solid particles or frame or body of passenger cars with a hydrophobin-containing solution at 30 to 80° C.

WO 03/53383 discloses the use of hydrophobin for treating keratin materials in cosmetic applications.

WO 03/10331 discloses a hydrophobin-coated sensor (a measuring electrode, for example) to which further substances, for example electro-active substances, antibodies or enzymes, are bound non-covalently.

None of the references cited discloses surface treating cured mineral building materials, natural stone, cast stone or ceramics.

It is an object of the present invention to provide novel techniques for treating such surfaces whereby at least one soil-repellent and/or hydrophobicizing and/or one preserving effect can be obtained.

We have found that this object is achieved by the use of a hydrophobin for treating a surface of a material selected from the group of cured mineral building materials, natural stone, cast stone or ceramic. In a preferred embodiment, a formulation comprising a hydrophobin and also at least one solvent is used for that purpose.

In a second aspect of the present invention there is provided a process for treating a surface, which comprises contacting said surface with at least one hydrophobin, wherein said surface comprises the surface of a material selected from the group of cured mineral building materials, natural stone, cast stone or ceramics.

In a third aspect of the present invention there is provided a surface coated with at least one hydrophobin, said surface comprising cured mineral building materials, natural stone, cast stone or ceramic.

We found that, surprisingly, even extremely small amounts of hydrophobins are sufficient for an effective, soil-repellent and/or hydrophobicizing and/or preserving treatment of the surfaces of cured mineral building materials, stones or ceramics.

### A DETAILED DESCRIPTION OF THE PRESENT INVENTION FOLLOWS

In accordance with the present invention, at least one hydrophobin is used for treating the surface of cured mineral building materials, natural stone, cast stone or ceramics. A mixture of a plurality of different hydrophobins can also be used.

The term “hydrophobins” as used herein shall refer hereinbelow to polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

where X may be any of the 20 naturally occurring amino acids (Phe, Leu, Ser, Tyr, Cys, Trp, Pro, His, Gln, Arg, lle, Met, Thr, Asn, Lys, Val, Ala, Asp, Glu, Gly). Each X may be the same or different. The indices next to X indicate in each case the number of amino acids, C represents cysteine, alanine, serine, glycine, methionine or threonine subject to the proviso that at least four of the amino acids identified by C are cysteine, and the indices n and m are independently natural numbers in the range from 0 to 500 and preferably in the range from 15 to 300.

The polypeptides of formula (I) are further characterized by the property (after coating of a glass surface) of increasing the contact angle of a drop of water by at least 20°, preferably at least 25°, more preferably at least 30° and most preferably at least 35°, compared with the contact angle formed by a drop of water of the same size with the uncoated glass surface, each measurement being carried out at room temperature.

The amino acids denoted C¹ to C⁸ are preferably cysteines; but they may also be replaced by other amino acids of similar bulk, preferably by alanine, serine, threonine, methionine or glycine. However, at least four, preferably at least 5, more preferably at least 6 and especially at least 7 of the C¹ to C⁸ positions shall consist of cysteines. Cysteines in proteins used according to the present invention may be present in reduced form or form disulfide bridges with one another. Particular preference is given to intramolecular formation of C—C bridges, in particular that involving at least one, preferably 2, more preferably 3 and most preferably 4 intramolecular disulfide bridges. In the case of the above-described exchange of cysteines for amino acids of similar bulk, it is advantageous for such C-positions to be involved in a pairwise exchange as are able to form intramolecular disulfide bridges with each other.

When cysteines, serines, alanines, glycines, methionines or threonines are used in the positions designated X, the numbering of the individual C-positions in the general formulae may change accordingly.

Preference is given to using hydrophobins of the general formula (II)

Xₙ—C¹—X₃₋₂₅—C²—X₀₋₂—C³—X₅₋₅₀—C⁴—X₂₋₃₅—C⁵—X₂₁₅—C⁶—X₀₋₂—C⁷—X₃₋₃₅—C⁸—Xₘ (II)

where X, C and the indices next to X are each as defined above, the indices n and m represent numbers in the range from 0 to 300, and the proteins are further distinguished by the abovementioned contact angle change.

Preference is given to using hydrophobins of the general formula (III)

Xₙ—C₁—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices next to X are each as defined above, the indices n and m represent numbers in the range from 0 to 200, and the proteins are further distinguished by the abovementioned contact angle change and furthermore at least six of the amino acids denoted C are cysteine. It is particularly preferable for all amino acids denoted C to be cysteine.

The residues Xₙ and Xₘ may be peptide sequences which may be naturally linked to a hydrophobin. However, either or both of the residues Xₙ and Xₘ may be peptide sequences which are not naturally linked to a hydrophobin. This also includes Xₙ and/or Xₘ residues in which a peptide sequence naturally occurring in a hydrophobin is extended by a peptide sequence not naturally occurring in a hydrophobin.

When Xₙ and/or Xₘ are peptide sequences which do not occur naturally in hydrophobins, the length of such sequences is generally at least 20 amino acids, preferably at least 35 amino acids, more preferably at least 50 amino acids and most preferably at least 100 amino acids. A residue of this kind, which is not naturally linked to a hydrophobin, will also be referred to as a fusion partner portion hereinbelow. This is intended to articulate the fact that the proteins consist of a one hydrophobin portion and a fusion partner portion which do not occur together in this form in nature. Such proteins will also be referred to as fusion proteins.

The fusion partner portion may be selected from a multiplicity of proteins. It is also possible for a plurality of fusion partner portions to be linked to one hydrophobin portion, for example to the amino terminus (Xₙ) or to the carboxy terminus (Xₘ) of the hydrophobin portion. But it is also possible, for example, to link two fusion partner portions to one position (Xₙ or Xₘ) of the protein used according to the present invention.

Particularly suitable fusion partner portions are polypeptides which occur naturally in microorganisms, in particular in E. coli or Bacillus subtilis. Examples of such fusion partner portions are the sequences yaad (SEQ ID NO:15 and 16), yaae (SEQ ID NO:17 and 18) and thioredoxin. Also highly suitable are fragments or derivatives of the aforementioned sequences which comprise only a portion, preferably 70% to 99% and more preferably 80% to 98%, of the said sequences, or in which individual amino acids or nucleotides have been altered compared with the sequence mentioned.

Proteins used according to the present invention may additionally be modified in their polypeptide sequence, for example by glycosylation, acetylation or else by chemical crosslinking, for example with glutaraldehyde.

One property of the proteins used according to the present invention is the change in surface properties when the surfaces are coated with the proteins. The change in surface properties can be determined experimentally by measuring the contact angle of a drop of water before and after coating of the surface with the protein and determining the difference between the two measurements.

A person skilled in the art will know in principle how to perform contact angle measurements. The precise experimental conditions for measuring the contact angle are described in the experimental portion. Under the conditions mentioned there, the proteins used according to the present invention have the property of increasing the contact angle of a water droplet on a glass surface by at least 20°, preferably at least 25° and more preferably at least 30°.

The positions of the polar and apolar amino acids in the hydrophobin portion of the hydrophobins known to date are preserved, resulting in a characteristic hydrophobicity plot. Differences in biophysical properties and hydrophobicity led to the hydrophobins known to date being classified in two classes, I and II (Wessels et al., Ann. Rev. Phytopathol., 1994, 32, 413-437).

The assembled membranes of class I hydrophobins are highly insoluble (even in a 1% by weight aqueous solution of sodium n-dodecyl sulfate (SDS) at an elevated temperature and can only be dissociated again by means of concentrated trifluoroacetic acid (TFA) or formic acid. In contrast, the assembled forms of class II hydrophobins are less stable. They can be dissolved again by means of just 60% by weight ethanol or 1% by weight SDS (at room temperature).

Comparison of the amino acid sequences reveals that the length of the region between cysteine C³ and cysteine C⁴ is distinctly shorter in class II hydrophobins than in class I hydrophobins. Class II hydrophobins further have more charged amino acids than class I.

Particularly preferred hydrophobins for embodying the present invention are those of the type dewA, rodA, hypA, hypB, sc3, basf1, basf2, which are structurally characterized in the sequence listing below. They may also be only parts or derivatives thereof. It is also possible to link a plurality of hydrophobin, preferably 2 or 3, of the same or a different structure together and to a corresponding suitable polypeptide sequence which is not naturally connected to a hydrophobin.

Of particular suitability for the practice of the present invention are further the fusion proteins having the polypeptide sequences indicated in SEQ ID NO: 20, 22, 24 and also the nucleic acid sequences coding therefor, in particular the sequences according to SEQ ID NO: 19, 21, 23. Particularly preferred embodiments further include proteins which, starting from the polypeptide sequences indicated in SEQ ID NO. 22, 22 or 24, result from the substitution, insertion or deletion of at least one, up to 10, preferably 5, more preferably 5% of all amino acids and which still possess at least 50% of the biological property of the starting proteins. Biological property of the proteins used according to the present invention is herein to be understood as meaning the above-described change in the contact angle by at least 20°.

Polypeptides used according to the present invention are chemically preparable by familiar techniques of peptide synthesis, for example by Merrifield's solid phase synthesis.

Naturally occurring hydrophobins can be isolated from natural sources using suitable methods. As an example, see Wösten et. al., Eur. J. Cell Bio. 63, 122-129 (1994) or WO 96/41882.

Non-naturally-occurring fusion proteins are preferably preparable by genetic engineering processes in which one nucleic acid sequence, in particular a DNA sequence, coding for the fusion partner and one nucleic acid sequence, in particular a DNA sequence, coding for the hydrophobin portion are combined such that the desired protein is generated in a host organism by gene expression of the combined nucleic acid sequence. Such a method of making is disclosed in our prior application DE 102005007480.4.

Suitable host, or producer, organisms for the method of making mentioned include prokaryotes (including Archaea) or eukaryotes, particularly bacteria including halobacteria and methanococci, fungi, insect cells, plant cells and mammalian cells, more preferably Escherichia coli, Bacillus subtilis, Bacillus megaterium, Aspergillus oryzea, Aspergillus nidulans, Aspergillus niger, Pichia pastoris, Pseudomonas spec., lactobacilli, Hansenula polymorpha, Trichoderma reesei, SF9 (or related cells), and so on.

For the purposes of the present invention expression constructs obtained, under the genetic control of regulatory nucleic acid sequences, a nucleic acid sequence coding for a polypeptide used according to the present invention, and also vectors comprising at least one of these expression constructs can be used to prepare hydrophobins.

Expression constructs used preferably comprise a promoter 5′ upstream of the particular coding sequence and a terminator sequence 3′ downstream of the particular coding sequence and also, if appropriate, further customary regulatory elements, each operatively linked to the coding sequence.

“Operative linkage” refers to the sequential arrangement of promoter, coding sequence, terminator and, if appropriate, further regulatory elements such that each of the regulatory elements is able to fulfill its function as required in expressing the coding sequence.

Examples of operatively linkable sequences are targeting sequences and also enhancers, polyadenylation signals and the like. Further regulatory elements comprise selectable markers, amplification signals, origins of replication and the like. Suitable regulatory sequences are described for example in Goeddel, Gene Expression Technology: Methods in Enzymology 185, Academic Press, San Diego, Calif. (1990).

In addition to these regulatory sequences, the natural regulation of these sequences may still be present upstream of the actual structural genes and, if appropriate, may have been genetically modified such that the natural regulation has been switched off and the expression of the genes has been enhanced.

A preferred nucleic acid construct advantageously also comprises one or more of the aforementioned enhancer sequences which are functionally linked to the promoter and which enable an enhanced expression of the nucleic acid sequence. Additional advantageous sequences such as further regulatory elements or terminators may also be inserted at the 3′ end of the DNA sequences.

The nucleic acids may be present in the construct in one or more copies. The construct may further comprise additional markers such as antibiotic resistances or auxotrophy-complementing genes, if appropriate for the purpose of selecting said construct.

Advantageous regulatory sequences for the process are present for example in promoters such as cos, tac, trp, tet, trp-tet, Ipp, lac, lpp-lac, laclq-T7, T5, T3, gal, trc, ara, rhaP(rhaPBAD) SP6, lambda-PR or imlambda-P promoter, which promoters are advantageously used in Gram-negative bacteria. Further advantageous regulatory sequences are present for example in the Gram-positive promoters amy and SP02, in the yeast or fungal promoters ADC1, MFalpha, AC, P-60, CYC1, GAPDH, TEF, rp28, ADH. It is also possible to use artificial promoters for regulation.

To express the nucleic acid construct in a host organism, it is advantageously inserted in a vector, for example a plasmid or phage, which permits optimal expression of the genes in the host. Vectors, as well as plasmids and phages, further include all other vectors known per se, i.e., for example viruses, such as SV40, CMV, baculovirus and adenovirus, transposons, IS elements, phasmids, cosmids, and linear or circular DNA, and also the Agrobacterium system.

These vectors may be replicated autonomously in the host organism or chromosomally. These vectors constitute a further form of the invention. Examples of suitable plasmids are, in E. coli, pLG338, pACYC184, pBR322, pUC18, pUC19, pKC30, pRep4, pHS1, pKK223-3, pDHE19:2, pHS2, pPLc236, pMBL24, pLG200, pUR290, pIN-III″3-B1, tgt11 or pBdCI, in Streptomyces, pIJ101, pIJ364, pIJ702 or pIJ361, in Bacillus pUB110, pC194 or pBD214, in Corynebacterium pSA77 or pAJ667, in fungi pALS1, pIL2 or pBB116, in yeasts 2alpha, pAG-1, YEp6, YEp13 or pEMBLYe23 or in plants pLGV23, pGHIac+, pBIN19, pAK2004 or pDH51. The plasmids mentioned constitute a small selection of the possible plasmids. Further plasmids are known per se and are to be found for example in the book Cloning Vectors (Eds. Pouwels P. H. et al. Elsevier, Amsterdam-New York-Oxford, 1985, ISBN 0 444 904018).

To express the other genes which are present, the nucleic acid construct advantageously further comprises 3′- and/or 5′-terminal regulatory sequences to enhance expression which are selected for optimal expression according to the choice of host organism and gene or genes.

These regulatory sequences are intended to enable the genes and protein expression to be specifically expressed. Depending on the host organism, this may mean for example that the gene is expressed or overexpressed only after induction, or that it is expressed and/or overexpressed immediately.

It is preferably the expression of the genes which have been introduced which may be positively influenced and thereby enhanced by the regulatory sequences or factors. The regulatory elements may thus be advantageously enhanced on the transcription level by using strong transcription signals such as promoters and/or enhancers. However, in addition to this, it is also possible to enhance translation by improving the stability of the mRNA for example.

In a further form of the vector, the vector comprising the nucleic acid construct or the nucleic acid may also advantageously be introduced into the microorganisms in the form of a linear DNA and be integrated into the genome of the host organism via heterologous or homologous recombination. This linear DNA may consist of a linearized vector such as a plasmid or only of the nucleic acid construct or the nucleic acid.

For optimal expression of heterologous genes in organisms it is advantageous to modify the nucleic acid sequences in accordance with the specific codon usage utilized in the organism. The codon usage can readily be determined with the aid of computer analyses of other known genes of the organism in question.

An expression cassette is prepared by fusing a suitable promoter to a suitable coding nucleotide sequence and to a terminator or polyadenylation signal. Common recombination and cloning techniques as described for example in T. Maniatis, E. F. Fritsch and J. Sambrook, Molecular Cloning: A Laboratory Manual, Cold Spring Harbor Laboratory, Cold Spring Harbor, N.Y. (1989) and also in T. J. Silhavy, M. L. Berman and L. W. Enquist, Experiments with Gene Fusions, Cold Spring Harbor Laboratory, Cold Spring Harbor, N.Y. (1984) and in Ausubel, F. M. et al., Current Protocols in Molecular Biology, Greene Publishing Assoc. and Wiley Interscience (1987), are used for this purpose.

To achieve expression in a suitable host organism, the recombinant nucleic acid construct, or gene construct, is advantageously inserted into a host-specific vector which provides optimal expression of the genes in the host. Vectors are known per se and may be taken for example from “Cloning Vectors” (Pouwels P. H. et al., Eds, Elsevier, Amsterdam-New York-Oxford, 1985).

It is possible to prepare, with the aid of the vectors, recombinant microorganisms which are, for example, transformed with at least one vector and which may be used for producing the polypeptides used according to the invention. Advantageously, the above-described recombinant constructs are introduced into a suitable host system and expressed. In this connection, familiar cloning and transfection methods known to the skilled worker, such as, for example, coprecipitation, protoplast fusion, electroporation, retroviral transfection and the like, are preferably used in order to cause said nucleic acids to be expressed in the particular expression system. Suitable systems are described, for example, in Current Protocols in Molecular Biology, F. Ausubel et al., Eds., Wiley Interscience, New York 1997, or Sambrook et al. Molecular Cloning: A Laboratory Manual. 2nd edition, Cold Spring Harbor Laboratory, Cold Spring Harbor Laboratory Press, Cold Spring Harbor, N.Y., 1989.

It is also possible to prepare homologously recombined microorganisms. For this purpose, a vector which comprises at least one section of a gene to be used according to the invention or of a coding sequence in which, if appropriate, at least one amino acid deletion, amino acid addition or amino acid substitution has been introduced in order to modify, for example functionally disrupt, the sequence (knockout vector), is prepared. The introduced sequence may, for example, also be a homolog from a related microorganism or be derived from a mammalian, yeast or insect source. Alternatively, the vector used for homologous recombination may be designed in such a way that the endogenous gene is, in the case of homologous recombination, mutated or otherwise altered but still encodes the functional protein (e.g. the upstream regulatory region may have been altered in such a way that expression of the endogenous protein is thereby altered). The altered section of the gene used according to the invention is in the homologous recombination vector. The construction of vectors which are suitable for homologous recombination is described, for example, in Thomas, K. R. and Capecchi, M. R. (1987) Cell 51:503.

Recombinant host organisms suitable for the nucleic acid used according to the invention or the nucleic acid construct are in principle any prokaryotic or eukaryotic organisms. Advantageously, microorganisms such as bacteria, fungi or yeasts are used as host organisms. Gram-positive or Gram-negative bacteria, preferably bacteria of the families Enterobacteriaceae, Pseudomonadaceae, Rhizobiaceae, Streptomycetaceae or Nocardiaceae, particularly preferably bacteria of the genera Escherichia, Pseudomonas, Streptomyces, Nocardia, Burkholderia, Salmonella, Agrobacterium or Rhodococcus, are advantageously used.

The organisms used in the process of preparing fusion proteins are, depending on the host organism, grown or cultured in a manner known to the skilled worker. Microorganisms are usually grown in a liquid medium which comprises a carbon source, usually in the form of sugars, a nitrogen source, usually in the form of organic nitrogen sources such as yeast extract or salts such as ammonium sulfate, trace elements such as iron salts, manganese salts and magnesium salts and, if appropriate, vitamins, at temperatures of between 0° C. and 10° C., preferably between 10° C. and 60° C., while being supplied with oxygen. In this connection, the pH of the nutrient liquid may be kept at a fixed value, i.e. may or may not be regulated during cultivation. The cultivation may be carried out batchwise, semibatchwise or continuously. Nutrients may be initially introduced at the beginning of the fermentation or be fed in subsequently in a semicontinuous or continuous manner. The enzymes may be isolated from the organisms by the process described in the examples or be used for the reaction as a crude extract.

Also suitable are processes for recombinantly preparing polypeptides or functional, biologically active fragments thereof, with a polypeptide-producing microorganism being cultured, expression of the polypeptides being induced if appropriate and said polypeptides being isolated from the culture. Polypeptides may also be produced in this way on an industrial scale if this is desired. The recombinant microorganism may be cultured and fermented by known methods. Bacteria may, for example, be propagated in TB medium or LB medium and at a temperature of from 20 to 40° C. and a pH of from 6 to 9. Suitable culturing conditions are described in detail, for example, in T. Maniatis, E. F. Fritsch and J. Sambrook, Molecular Cloning: A Laboratory Manual, Cold Spring Harbor Laboratory, Cold Spring Harbor, N.Y. (1989).

If the polypeptides are not secreted into the culture medium, the cells are then disrupted and the product is obtained from the lysate by known protein isolation processes. The cells may be disrupted, as desired, by means of high-frequency ultrasound, by means of high pressure, such as, for example, in a French pressure cell, by means of osmolysis, by the action of detergents, lytic enzymes or organic solvents, by means of homogenizers or by a combination of two or more of the processes listed.

Polypeptides may be purified using known chromatographic methods such as molecular sieve chromatography (gel filtration), such as Q Sepharose chromatography, ion exchange chromatography and hydrophobic chromatography, and also using other customary methods such as ultrafiltration, crystallization, salting-out, dialysis and native gel electrophoresis. Suitable processes are described, for example, in Cooper, F. G., Biochemische Arbeitsmethoden, Verlag Walter de Gruyter, Berlin, New York or in Scopes, R., Protein Purification, Springer Verlag, New York, Heidelberg, Berlin.

It may be advantageous to isolate the recombinant protein by using vector systems or oligonucleotides which extend the cDNA by particular nucleotide sequences and thereby code for altered polypeptides or fusion proteins which are used, for example, to simplify purification. Examples of suitable modifications of this kind are “tags” acting as anchors, such as the modification known as the hexa-histidine anchor, or epitopes which can be recognized as antigens by antibodies (described, for example, in Harlow, E. and Lane, D., 1988, Antibodies: A Laboratory Manual. Cold Spring Harbor (N.Y.) Press). Other suitable tags are, for example, HA, calmodulin-BD, GST, MBD; chitin-BD, steptavidin-BD-avi-tag, Flag-tag, T7 etc. These anchors may be used for attaching the proteins to a solid support such as a polymer matrix, for example, which may, for example, be packed in a chromatography column, or may be used on a microtiter plate or on another support. The corresponding purification protocols can be obtained from the commercial affinity tag suppliers.

The proteins prepared as described may be used either directly as fusion proteins or, after cleaving off and removing the fusion partner portion, as “pure” hydrophobins.

When removal of the fusion partner portion is intended, it is advisable to incorporate a potential cleavage site (specific recognition site for proteases) in the fusion protein between the hydrophobin portion and the fusion partner portion. Suitable cleavage sites include in particular those peptide sequences which otherwise occur neither in the hydrophobin portion nor in the fusion partner portion, as is readily determined by means of bioinformatics tools. Particularly suitable are for example BrCN cleavage on methionine or protease-mediated cleavage with factor Xa, enterokinase cleavage, thrombin, TEV (tobacco etch virus protease) cleavage.

The surfaces which, according to the present invention, are to be treated with hydrophobins comprise the surface of a material selected from the group of cured mineral building materials, natural stone, cast stone or ceramic. Such surfaces are to be found in particular in the building construction sector, both indoors and outdoors.

Cured mineral building materials for the purposes of this invention are stonelike masses obtainable by mixing essentially inorganic building materials with water and subsequent curing due to chemical and/or physical reactions. The starting materials are hydraulically curing building materials which cure both in air and in water, or air-curing building materials, which cure in air only. The building materials may further comprise steam-cured building materials for example.

Examples of such cured building materials comprise in particular concrete or mortar, each obtainable from cements, such as Portland cement, alumina cement or Puzzolan cement and their mixtures with coarse aggregates such as sand, gravel or expanded materials as well as water. They may in known manner further comprise further inorganic and/or organic auxiliary materials, such as concrete superplasticizers for example. Further examples of cured building materials comprise gypsum, lime or renders for interior and exterior applications.

Natural stone comprises naturally occurring stone such as sandstone, granite, gneiss, slate, lime or marble. These kinds of stone can be used not only as broken stone in an irregular shape but also in the form of molded structural components, for example as building stone, windowsills, steps, parapets, doorposts, slabs for surfacing, floor slabs, roofing slabs, decorative elements or sculptures.

Cast stone comprises structural components which can be used similarly to natural stone but which do not come from natural sources but are generally industrially manufactured. Examples comprise tiles, clinker, sand-lime brick, concrete block, aerated concrete block or expanded clay block.

The term “ceramic” is known in principle to one skilled in the art. Ceramic is a collective designation for articles made of nonmetallic inorganic compounds and normally rendered ready to use by high-temperature operations.

Ceramics can be clay-ceramic materials, having at least 20% by weight of clay mineral in the raw mix, and specialty-ceramic materials, which are either clay mineral free or have only a low clay mineral content. Ceramics can be fine or coarse, porous or dense. Ceramic materials, as will be known in principle, may have glazes. The glazes may be colored as well as colorless.

Examples of clay-ceramic materials comprise structural ceramic articles such as masonry wall brick or clinker, clay pipes, chamotte brick, roofing tiles, pottery-products, claystone goods, limestone goods, feldsparstone goods, stoneware, hard porcelain, soft porcelain or tiles, which may also be glazed.

Examples of specialty ceramic articles comprise silica stone, clay-bound silicon carbide, melt-cast stone, oxide-ceramic insulants, ceramic filters, carbide-ceramic materials, electroceramics, magnetoceramics or dental ceramics.

Further details concerning ceramics can be found for example in Buchner et al., “Industrielle Anorganische Chemie”, VCH Verlag, Weinheim, New York 1986, pages 431 to 476.

The surfaces may be made up of several, different materials. One example is a tiled wall comprising a surface made up of ceramic tiles and tile mortar. The surfaces may further comprise different kinds of materials, for example embedded parts of metal.

Hydrophobins can be used in substance when they are used according to the present invention for treating the surfaces mentioned. Preferably, however, the hydrophobins are used as formulations or compositions in at least one suitable solvent.

The choice of hydrophobins to embody the invention is not restricted. It is possible to use one hydrophobin or else a plurality of different ones. A person skilled in the art will make a suitable choice. For example, it is possible to use fusion proteins such as for example yaad-Xa-dewA-his (SEQ ID NO: 19) or yaad-Xa-rodA-his (SEQ ID NO: 21), in which case the yaad fusion partner may also be in a shortened state.

The solvents for formulations may comprise water and/or organic solvents. Solvent mixtures can also be used. The identity of the solvent depends for example on the hydrophobin, the identity of the surface to be treated and also the use, and is appropriately selected by one skilled in the art.

The solvent preferably comprises water or mixtures of water and water-miscible, organic solvents. Examples of such organic solvents comprise water-miscible monohydric or polyhydric alcohols, for example methanol, ethanol, n-propanol, i-propanol, ethylene glycol, propylene glycol or glycerol. Ether alcohols are also a possibility. Examples comprise monoalkyl ethers of (poly)ethylene or (poly)propylene glycols such as ethylene glycol monobutyl ether. The identity and amount of the water-soluble, organic solvents are chosen by one skilled in the art.

To prepare the composition used according to the present invention, it may be preferable to employ the as-synthesized, as-isolated and/or as-purified aqueous hydrophobin solutions. These may still comprise, depending on their purity, residues of auxiliaries from the synthesis. But it is also possible to isolate the hydrophobins initially as substance, for example by freeze drying, and for them only to be formulated in a second step.

The amount of hydrophobin in the formulation can be determined by one skilled in the art according to the identity of the surface and/or the planned use. But even relatively small amounts will be sufficient to achieve an effect, i.e., a change to the properties of the surface. An amount of 0.0001% to 1% by weight based on the sum total of all constituents of the formulation has been found satisfactory without the invention thereby being restricted to this range. The amount is preferably in the range from 0.0005% to 0.5% by weight and more preferably in the range from 0.001% to 0.1% by weight.

The formulation may optionally additionally comprise further components, for example admixture materials and/or assistants. Examples of such components comprise in particular surfactants, for example anionic, nonionic, amphoteric and/or cationic surfactants. Examples of further admixture materials comprise acids or bases, for example carboxylic acids or ammonia, buffer systems, polymers, inorganic particles such as SiO₂ or silicates, dyes or biocides.

According to the present invention, the surface is treated by contacting the surface with hydrophobin or with a composition comprising at least one hydrophobin and also at least one solvent.

The contacting may be effected for example by spraying, brushing or rolling or else by dipping the entire article into the formulation. The latter is naturally only possible with articles which have not been installed. The treatment time is decided by one skilled in the art. It can take a few seconds to several hours. After treatment, the surface may be rinsed, with water for example, to remove excess treating solution.

The treatment can also be effected in combination with a cleaning of the surface. This is done using the cleaning composition comprising at least one hydrophobin, at least one surfactant and also at least one solvent.

The treatment can be carried out at temperatures below room temperature, at room temperature or elevated temperatures, for example at 20 to 100° C., preferably 20 to 60° C.

After treatment with the composition, the treated surface is dried. The drying of the treated surface can take place quasi of itself at room temperature, or drying can also be carried out at elevated temperatures.

The treatment and also, if appropriate, the drying of the surface may be followed by a thermal aftertreatment of the surface at elevated temperatures, for example at temperatures of up to 120° C. The thermal aftertreatment can also be carried out combined with the drying. The thermal aftertreatment temperatures are preferably in the range from 30 to 100° C., more preferably in the range from 40 to 80° C. and for example in the range from 50 to 70° C. The treatment time is decided by one skilled in the art, it can be in the range from 1 min to 10 h for example. The thermal after treatment can be effected, depending on the nature of the treatment, for example by irradiating the surface with an IR radiator or blowing with warm streams of air.

The process of the present invention provides a surface selected from the group of cured mineral building materials, natural stone, cast stone or ceramics which comprises a coating comprising at least one hydrophobin. The coating generally comprises at least a monomolecular layer of hydrophobin on the surface.

The treatment according to the present invention provides at least a soil-repellent and/or hydrophobicizing and/or preserving effect. In the general case, at least two of the benefits are obtained, in particular combined hydrophobicization and soil repellency. The hydrophobins have a distinct effect even in small amounts. In the general case, treatment with a composition comprising just 0.01% by weight of hydrophobins will lead to an effective change on the surface.

The soil-repellent effect can be determined by means of methods known in principle, for example by comparing the detachability of soil by rinsing off with water for an untreated surface against a surface treated with hydrophobins. The degree of hydrophobicization can be determined in a known manner by measuring the contact angle.

The treatment according to the present invention is particularly useful for ceramic surfaces, such as tiles for example, where both a soil-repellent and a hydrophobicizing effect are obtained. This is a significant advantage particularly in wet rooms, such as bathrooms for example.

The examples which follow illustrate the invention:

### Part A:

### Preparation and Testing of Hydrophobins Used According to Invention

### Example 1

### Preliminary Work for the Cloning of yaad-His₆/yaaE-His₆

A polymerase chain reaction was carried out with the aid of the oligonucleotides HaI570 and HaI571 (HaI 572/HaI 573). The template DNA used was genomic DNA of the bacterium Bacillus subtilis. The PCR fragment obtained comprised the coding sequence of the Bacillus subtilis yaaD/yaaE gene and, at their termini, in each case an NcoI and, respectively, BgIII restriction cleavage site. The PCR fragment was purified and cut with the restriction endonucleases NcoI and BgIII. This DNA fragment was used as insert and cloned into the vector pQE60 from Qiagen, which had previously been linearized with the restriction endonucleases NcoI and BgIII. The vectors thus obtained, pQE60YAAD#2/pQE60YaaE#5, may be used for expressing proteins consisting of YAAD::HIS₆ and YAAE::HIS6, respectively.

Hal570: gcgcgcccatggctcaaacaggtactga
Hal571: gcagatctccagccgcgttcttgcatac
Hal572: ggccatgggattaacaataggtgtactagg
Hal573: gcagatcttacaagtgccttttgcttatattcc

### Example 2

### Cloning of yaad Hydrophobin DewA-His₆

A polymerase chain reaction was carried out with the oligonucleotide KaM 416 and KaM 417. The template DNA used was genomic DNA of the mold Aspergillus nidulans. The PCR fragment obtained comprised the coding sequence of the hydrophobin gene dewA and an N-terminal factor Xa proteinase cleavage site. The PCR fragment was purified and cut with the restriction endonuclease BamHI. This DNA fragment was used as insert and cloned into the pQE60YAAD#2 vector previously linearized with the restriction endonuclease BgIII.

The vector thus obtained, #508, may be used for expressing a fusion protein consisting of YAAD::Xa::dewA::HIS₆.

KaM416:
GCAGCCCATCAGGGATCCCTCAGCCTTGGTACCAGCGC
KaM417:
CCCGTAGCTAGTGGATCCATTGAAGGCCGCATGAAGTTCTCCGTCTCCGC

### Example 3

### Cloning of yaad Hydrophobin RodA-His₆

The plasmid #513 was cloned analogously to plasmid #508, using the oligonucleotides KaM 434 and KaM 435.

KaM434:
GCTAAGCGGATCCATTGAAGGCCGCATGAAGTTCTCCAAGCTGC
KaM435:
CCAATGGGGATCCGAGGATGGAGCCAAGGG

### Example 4

### Cloning of yaad Hydrophobin BASF1-His₆

The plasmid #507 was cloned analogously to plasmid #508, using the oligonucleotides KaM 417 and KaM 418. The template DNA employed was an artificially synthesized DNA sequence—hydrophobin BASF1 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 5

### Cloning of yaad Hydrophobin BASF2-His₆

The plasmid #506 was cloned analogously to plasmid #508, using the oligonucleotides KaM 417 and KaM 418. The template DNA employed was an artificially synthesized DNA sequence—hydrophobin BASF2 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### Example 6

### Cloning of yaad Hydrophobin SC3-His₆

The plasmid #526 was cloned analogously to plasmid #508, using the oligonucleotides KaM464 and KaM465. The template DNA employed was Schyzophyllum commune cDNA (see appendix).

KaM464:
CGTTAAGGATCCGAGGATGTTGATGGGGGTGC
KaM465:
GCTAACAGATCTATGTTCGCCCGTCTCCCCGTCGT

### Example 7

### Fermentation of the Recombinant E. coli Strain yaad Hydrophobin DewA-His₆

Inoculation of 3 ml of LB liquid medium with an E. coli strain expressing yaad hydrophobin DewA-His₆ in 15 ml Greiner tubes. Incubation on a shaker at 200 rpm at 37° C. for 8 h. In each case 2 1 l Erlenmeyer flasks with baffles and 250 ml of LB medium (+100 μg/ml ampicillin) were inoculated with 1 ml of preculture and incubated on a shaker at 180 rpm at 37° C. for 9 h. Inoculate 13.5 l of LB medium (+100 μg/ml ampicillin) with 0.5 l of preculture (OD₆₀₀ₙₘ 1:10 measured against H₂O) in a 20 l fermenter. Addition of 140 ml of 100 mM IPTG at an OD₆₀ₙₘ of ˜3.5. After 3 h, cool fermenter to 10° C. and remove fermentation broth by centrifugation. Use cell pellet for further purification.

### Example 8

### Purification of the Recombinant Hydrophobin Fusion Protein

### (Purification of Hydrophobin Fusion Proteins Possessing a C-Terminal His6 Tag)

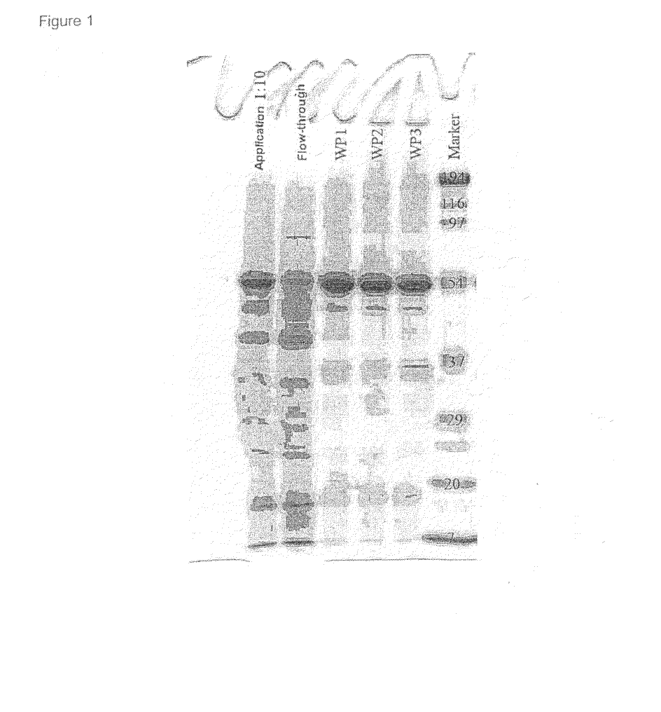

100 g of cell pellet (100-500 mg of hydrophobin) were made up with 50 mM sodium phosphate buffer, pH 7.5, to a total volume of 200 ml and resuspended. The suspension was treated with an Ultraturrax type T25 (Janke and Kunkel; IKA-Labortechnik) for 10 minutes and subsequently, for the purposes of degrading the nucleic acids, incubated with 500 units of benzonase (Merck, Darmstadt; order No. 1.01697.0001) at room temperature for 1 hour. Prior to cell disruption, a filtration was carried out using a glass cartridge (P1). For the purposes of disrupting the cells and of shearing of the remaining genomic DNA, two homogenizer runs were carried out at 1500 bar (Microfluidizer M-110EH; Microfluidics Corp.). The homogenate was centrifuged (Sorvall RC-5B, GSA Rotor, 250 ml centrifuge beaker, 60 minutes, 4° C., 12 000 rpm, 23 000 g), the supernatant was put on ice and the pellet was resuspended in 100 ml of sodium phosphate buffer, pH 7.5. Centrifugation and resuspension were repeated three times, the sodium phosphate buffer comprising 1% SDS at the third repeat. After resuspension, the solution was stirred for one hour, followed by a final centrifugation (Sorvall RC-5B, GSA Rotor, 250 ml centrifuge beaker, 60 minutes, 4° C., 12 000 rpm, 23 000 g). According to SDS-PAGE analysis, the hydrophobin is present in the supernatant after the final centrifugation (FIG. 1). The experiments show that the hydrophobin is present in the corresponding E. coli cells probably in the form of inclusion bodies. 50 ml of the hydrophobin-containing supernatant were applied to a 50 ml nickel-Sepharose High Performance 17-5268-02 column (Amersham) equilibrated with 50 mM Tris-Cl buffer, pH 8.0. The column was washed with 50 mM Tris-Cl buffer, pH 8.0, and the hydrophobin was subsequently eluted with 50 mM Tris-+Cl buffer, pH 8.0, comprising 200 mM imidazole. For the purpose of removing the imidazole, the solution was dialyzed against 50 mM Tris-Cl buffer, pH 8.0.

FIG. 1 depicts the purification of the hydrophobin prepared:

| | |
|---|---|
| Lane 1: | solution applied to nickel-Sepharose column (1:10 dilution) |
| Lane 2: | flow-through = eluate of washing step |
| Lanes 3-5: | OD 280 peaks of elution fractions |

The hydrophobin of FIG. 1 has a molecular weight of approx. 53 kD. Some of the smaller bands represent degradation products of hydrophobin.

### Example 9

### Performance Testing; Characterization of the Hydrophobin by Changing the Contact Angle of a Water Droplet on Glass

### Substrate:

Glass (window glass, Süddeutsche Glas, Mannheim, Germany):

Hydrophobin concentration: 100 μg/ml

Incubation of glass slides overnight (temperature 80° C.) in 50 mM sodium acetate (pH 4)+0.1% by weight of Tween 20

followed by, washing glass slides with hydrophobin coating in distilled water

followed by incubation: 10 min/80° C./1% by weight of aqueous sodium n-dodecyl sulfate solution (SDS) in distilled water

washing in distilled water

The samples are air dried (room temperature) and subjected at room temperature to a determination of the contact angle (in degrees) of a droplet of 5 μl of water.

The contact angle measurement was determined on a Dataphysics Contact Angle System OCA 15+, Software SCA 20.2.0. (November 2002). The measurement was carried out in accordance with the manufacturer's instructions.

Untreated glass gave a contact angle of 30±5°; a coating with the functional hydrophobin of Example 8 (yaad-dewA-his₆) gave contact angle of 75±5°.

### Part B:

### Use of Hydrophobins for Soil-Repellent Coating on Ceramic Surfaces

### Solution Used:

The performance tests were carried out using a solution in water of the fusion protein yaad-Xa-dewA-his (SEQ ID NO: 19) prepared according to Example 8. Concentration of the hydrophobin in solution: 100 μg/ml (0.01% by weight).

### Ceramic Surface Used:

Ceramic tile, shiny white, 10 cm×15 cm (from Novocker), wiped down with ethanol and water.

### Soil Used:

The tests were carried out using IKW ballast soil (in accordance with Seifen, Fette, Öle, Wachse (SÖFW)-Journal, Volume 124, 14/98, page 1029)

### Method of Treatment

A tile had 2 g of the abovementioned, aqueous hydrophobin solution having a concentration of 100 μg/ml dripped onto it (1.3 μm of hydrophobin/cm²) and gently distributed with a cloth to cover the entire surface. The tile was then left to lie to air dry for 24 h.

The tile was subsequently rinsed off with water and placed for 3×10 min in a glass beaker with water. Fresh water was used for each rinse. The tile was then left to air dry upright.

### Contact Angle Measurement and Soil-Repellent Effect

The treated tile gave a contact angle measurement against a water droplet of 56° (mean of 10 measurements). For comparison, an untreated tile has a contact angle of 20°. The tile had thus been distinctly hydrophobicized.

The treated tile and, in comparison, an untreated tile were each spotted with 50, 100 and 200 μg of IKW ballast soil using a transfer pipette and left to dry at room temperature for one h.

The tiles were then rinsed 3 times With 500 ml of water each time. While this did not detach the soil from the untreated surface, partial soil detachment was observed for the hydrophobin-pretreated tile.

The pretreatment of the tile with hydrophobin thus led to reduced soil adhesion and to a hydrophobicization of the ceramic surface.

Assignment of sequence names to DNA and polypeptide sequences in sequence listing

| | |
|---|---|
| dewA DNA and polypeptide sequences | SEQ ID NO: 1 |
| dewA polypeptide sequence | SEQ ID NO: 2 |
| rodA DNA and polypeptide sequences | SEQ ID NO: 3 |
| rodA polypeptide sequence | SEQ ID NO: 4 |
| hypA DNA and polypeptide sequences | SEQ ID NO: 5 |
| hypA polypeptide sequence | SEQ ID NO: 6 |
| hypB DNA and polypeptide sequences | SEQ ID NO: 7 |
| hypB polypeptide sequence | SEQ ID NO: 8 |
| sc3 DNA and polypeptide sequences | SEQ ID NO: 9 |
| sc3 polypeptide sequence | SEQ ID NO: 10 |
| basf1 DNA and polypeptide sequences | SEQ ID NO: 11 |
| basf1 polypeptide sequence | SEQ ID NO: 12 |
| basf2 DNA and polypeptide sequences | SEQ ID NO: 13 |
| basf2 polypeptide sequence | SEQ ID NO: 14 |
| yaad DNA and polypeptide sequences | SEQ ID NO: 15 |
| yaad polypeptide sequence | SEQ ID NO: 16 |
| yaae DNA and polypeptide sequences | SEQ ID NO: 17 |
| yaae polypeptide sequence | SEQ ID NO: 18 |
| yaad-Xa-dewA-his DNA and polypeptide | SEQ ID NO: 19 |
| sequences | |
| yaad-Xa-dewA-his polypeptide sequence | SEQ ID NO: 20 |
| yaad-Xa-rodA-his DNA and polypeptide | SEQ ID NO: 21 |
| sequences | |
| yaad-Xa-rodA-hiS polypeptide sequence | SEQ ID NO: 22 |
| yaad-Xa-basf1-his DNA and polypeptide | SEQ ID NO: 23 |
| sequences | |
| yaad-Xa-basf1-his polypeptide | SEQ ID NO: 24 |
| sequence | |

1-2. (canceled)

3. A process for treating a surface, which comprises contacting said surface with at least one hydrophobin, wherein said surface comprises the surface of a material selected from the group of cured mineral building materials, natural stone, cast stone or ceramics.

4. The process according to claim 3 wherein said treating is effected using a composition comprising a solvent as well as at least one hydrophobin.

5. The process according to claim 3 wherein said solvent comprises water.

6. The process according to claim 3 wherein the amount of hydrophobin in said composition is in the range from 0.0001% to 1% by weight based on the sum total of all constituents of said formulation.

7. A surface coated with at least one hydrophobin, said surface comprising the surface of a material selected from the group of cured mineral building materials, natural stone, cast stone or ceramic.

8. The coated surface according to claim 7 which is characterized by soil repellency.

9. The coated surface according to claim 7 which is characterized by hydrophobicity.

10. The process according to claim 4 wherein said solvent comprises water.

11. The process according to claim 4 wherein the amount of hydrophobin in said composition is in the range from 0.0001% to 1% by weight based on the sum total of all constituents of said formulation.

12. The process according to claim 5 wherein the amount of hydrophobin in said composition is in the range from 0.0001% to 1% by weight based on the sum total of all constituents of said formulation.

13. The coated surface according to claim 8 which is characterized by hydrophobicity.
